(19) United States
(12) Patent Application Publication
(10) Pub. No.: US 2013/0036320 A1
(43) Pub. Date: Feb. 7, 2013

(54) IMAGE FORMING APPARATUS, FEEDING CONTROL METHOD, AND COMPUTER PROGRAM PRODUCT

(71) Applicant: Yuichi YOSHIMURA, Kanagawa (JP)

(72) Inventor: Yuichi YOSHIMURA, Kanagawa (JP)

(73) Assignee: RICOH COMPANY, LTD., Tokyo (JP)

(21) Appl. No.: 13/559,043

(22) Filed: Jul. 26, 2012

(30) Foreign Application Priority Data
Aug. 3, 2011 (JP) 2011-170545

(51) Int. Cl. G06F 1/32

(52) U.S. Cl. 713/323

(57) ABSTRACT

An image forming apparatus includes a main power supply configured to feed power to components of the image forming apparatus; a secondary battery configured to be charged with power from the main power supply or a solar battery; a secondary battery deterioration detector configured to monitors a charging voltage drop of the secondary battery and to detect deterioration of the secondary battery; a secondary battery charge unit configured to charge the secondary battery when the secondary battery deterioration detector detects deterioration of the secondary battery in an energy-saving mode; and an energy-saving mode control unit configured to switch a power source for the image forming apparatus from the secondary battery to the main power supply to continue in the energy-saving mode when the secondary battery deterioration detector detects deterioration of the secondary battery in the energy-saving mode.

### CROSS-REFERENCE TO RELATED APPLICATION

The present application claims priority to and incorporates by reference the entire contents of Japanese Patent Application No. 2011-170545 filed in Japan on Aug. 3, 2011.

### BACKGROUND OF THE INVENTION

1. Field of the Invention

The present invention relates to an image forming apparatus, a feeding control method, and a computer program product.

2. Description of the Related Art

Reducing the power consumption of image forming apparatuses is an essential task for tackling global environmental issues and for reducing running costs. A system using a method of reducing power consumption is known in which, when an image forming apparatus is in operation, a solar battery is used to charge a secondary battery and, when in energy-saving mode, the secondary battery is used to keep the standby power at 0 W.

For example, Japanese Patent No. 4365052 discloses a technology in which, for the purpose of reducing power consumption in energy-saving mode, a secondary battery is provided that is charged by a main power supply or a solar battery and, when in energy-saving mode, the operation of the main power supply is stopped and power is fed from the secondary battery to the respective components of the apparatus main unit. Japanese Patent No. 4365052 discloses a unit including a power supply threshold detector that monitors the condition of the power feed to the secondary battery and in which, when the power supply threshold detector detects that the voltage of the secondary battery drops to a threshold or less in energy-saving mode, power feeding from the secondary battery to the respective components of the apparatus main unit is stopped and the power source is switched to the main power supply to continue in energy-saving mode.

However, in the above-described conventional technology, if an available time for the secondary battery in energy-saving mode is short even though the solar battery has generated a predetermined amount of power or more and that power has been stored in the secondary battery, the secondary battery deteriorates. The deterioration is not taken into account in the conventional technology. For this reason, the conventional technology has a problem in that, when the secondary battery deteriorates, the time for which the secondary battery is used in energy-saving mode shortens and accordingly energy-saving performance is reduced.

Therefore, there is a need for an apparatus and a method capable of maintaining the effects of power consumption reduction by detecting deterioration of a secondary battery and by performing control that takes deterioration of the secondary battery into account.

### SUMMARY OF THE INVENTION

It is an object of the present invention to at least partially solve the problems in the conventional technology.

According to an embodiment, there is provided an image forming apparatus that includes a main power supply configured to feed power to components of the image forming apparatus; a secondary battery configured to be charged with power from the main power supply or a solar battery; a secondary battery deterioration detector configured to monitor a charging voltage drop of the secondary battery and to detect deterioration of the secondary battery; a secondary battery charge unit configured to charge the secondary battery when the secondary battery deterioration detector detects deterioration of the secondary battery in an energy-saving mode; and an energy-saving mode control unit configured to switch a power source for the image forming apparatus from the secondary battery to the main power supply to continue in the energy-saving mode when the secondary battery deterioration detector detects deterioration of the secondary battery in the energy-saving mode.

According to another embodiment, there is provided a feeding control method performed by an image forming apparatus that includes a main power supply configured to feed power to components of the image forming apparatus and a secondary battery configured to be charged with power from the main power supply or a solar battery. The feeding control method includes detecting deterioration of the secondary battery by monitoring a charging voltage drop of the secondary battery; charging the secondary battery when deterioration of the secondary battery is detected in an energy-saving mode; and switching a power source for the image forming apparatus from the secondary battery to the main power supply to continue in the energy-saving mode when deterioration of the secondary battery is detected in the energy-saving mode.

According to still another embodiment, there is provided a computer program product that includes a non-transitory computer readable medium including programmed instructions. The instructions, when executed by a processor of an image forming apparatus that includes a main power supply configured to feed power to components of the image forming apparatus and a secondary battery configured to be charged with power from the main power supply or a solar battery, cause the processor to execute detecting deterioration of the secondary battery by monitoring a charging voltage drop of the secondary battery; charging the secondary battery when deterioration of the secondary battery is detected in an energy-saving mode; and switching a power source for the image forming apparatus from the secondary battery to the main power supply to continue in the energy-saving mode when deterioration of the secondary battery is detected in the energy-saving mode.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram depicting a configuration of an image forming apparatus that includes a power supply circuit unit according to an embodiment;

FIG. 2 is a graph depicting detection and control of a threshold voltage of the secondary battery performed by a power supply threshold detection circuit shown in FIG. 1;

FIG. 3 is a graph depicting determination of the deterioration of the secondary battery by monitoring the number of times the secondary battery is forcibly charged;

FIG. 4 is a graph depicting variation in the available time for the secondary battery;

FIG. 5 is a graph depicting variation in the charge complete time of the secondary battery;

FIG. 6 is a graph depicting a sudden voltage drop of the secondary battery in the energy-saving mode; and

FIG. 7 is a flowchart of operations of control of the secondary battery in the energy-saving mode according to the embodiment.

### DETAILED DESCRIPTION OF THE PREFERRED EMBODIMENTS

An embodiment of an image forming apparatus, a feeding control method, and a program according to the present invention will be describe in detail below with reference to the accompanying drawings.

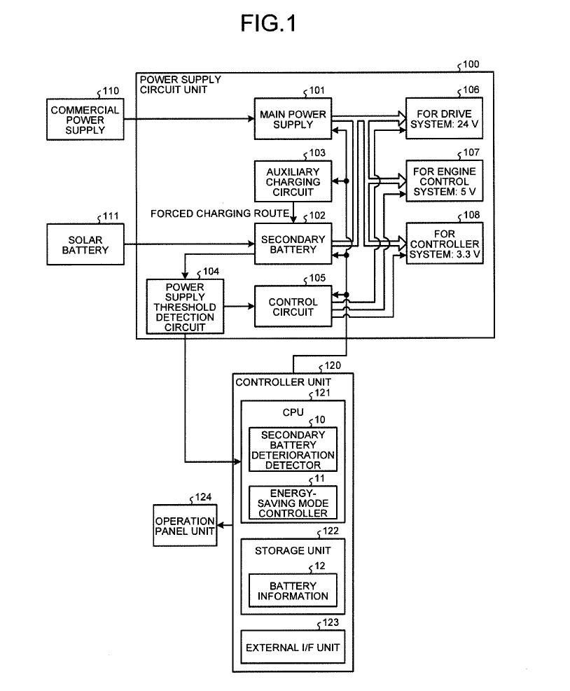

FIG. 1 is a block diagram of a configuration of an image forming apparatus that includes a power supply circuit unit according to an embodiment. In FIG. 1, a power supply circuit unit 100 includes a main power supply 101, a secondary battery 102, an auxiliary charging circuit 103, a power supply threshold detection circuit 104, a control circuit 105, a power supply output unit for drive system 106, a power supply output unit for engine control system 107, and a power supply output unit for controller system 108. The auxiliary charging circuit 103 has a function of forced charging. A controller unit 120 includes a CPU 121 having functions of a secondary battery deterioration detector 10 and an energy-saving mode controller 11, which are described below; a storage unit 122 that stores battery information 12; and an external interface (I/F) unit 123. In FIG. 1, the reference number 110 denotes the commercial power supply, the reference number 111 denotes a solar battery, and the reference number 124 denotes an operation panel unit.

In FIG. 1, the CPU 121 has the functions of the secondary battery deterioration detector 10 and the energy-saving mode controller 11, which are described below. The secondary battery deterioration detector 10 monitors a charging voltage drop of the secondary battery 102 due to feeding according to the value detected by the power supply threshold detection circuit 104 in order to detect deterioration of the secondary battery 102. When the secondary battery deterioration detector 10 detects deterioration of the secondary battery 102 in energy-saving mode, the energy-saving mode controller 11 switches the power source from the secondary battery 102 to the main power supply 101 to continue in the energy-saving mode. The storage unit 122 has a function of saving the battery information 12. The operation panel unit 124 has a function of displaying a deterioration notification and, when deterioration of the secondary battery 102 occurs, the operation panel unit 124 notifies a user of the deterioration of the secondary battery 102 with an instruction from the controller unit 120.

The main power supply 101 rectifies an alternating-current voltage from the commercial power supply 110 and generates a direct-current voltage to be fed to the respective components of the image forming apparatus. The secondary battery 102 is charged by the main power supply 101 via at least one of the solar battery 111 and the auxiliary charging circuit 103 and outputs a direct-current voltage in the energy-saving mode of the image forming apparatus. The auxiliary charging circuit 103 charges the secondary battery 102 via the main power supply 101. The power supply threshold detection circuit 104 reads, from the secondary battery 102, the value of fed voltage and detects how much the secondary battery 102 is charged (charging voltage capacity). The control circuit 105 controls feeding from the main power supply 101 and the secondary battery 102 of the power supply circuit unit 100 and controls switching between the main power supply 101 and the secondary battery 102.

The drive system power supply output 106 outputs a voltage of 24 V DC to a drive system with an instruction signal from the CPU 121. The power supply output unit for engine control system 107 outputs a voltage of 5 V DC to the engine control system with an instruction signal from the CPU 121. The power supply output unit for controller system 108 outputs a voltage of 3.3 V DC to the controller system with an instruction signal from the CPU 121.

The controller unit 120 controls the entire image forming apparatus, i.e., performs each control particularly on the power supply circuit unit 100 described below in this example. The storage unit 122 of the controller unit 120 stores the battery information 12 on the secondary battery 102. The operation panel unit 124 includes, for example, a liquid crystal operation display panel. The operation panel unit 124 makes a display regarding the life or replacement of the secondary battery 102 to the user.

The main power supply 101 is connected to the commercial power supply 110 and feeds power to the respective components of the image forming apparatus. The secondary battery 102 is charged by the main power supply 101 or the solar battery 111. When the secondary battery deterioration detector 10 detects deterioration of the secondary battery 102 in the energy-saving mode, the energy-saving mode controller 11 causes the auxiliary charging circuit 103 to forcibly charge the secondary battery 102. When the secondary battery deterioration detector 10 detects deterioration of the secondary battery 102 in the energy-saving mode, the energy-saving mode controller 11 switches the feeding operation (the power source) from the secondary battery 102 to the main power supply 101 to continue in the energy-saving mode. When deterioration of the secondary battery 102 occurs, the operation panel unit 124 notifies the user of deterioration of the secondary battery 102 with an instruction from the controller unit 120.

The solar battery 111 generates power according to the intensity of solar power/illumination light in daylight or indoor lighting and the generated power is used to charge the secondary battery 102. The battery information stored in the storage unit 122 contains, for example, the number of times the secondary battery 102 is forcibly charged and a reference number of times thereof, the available time for the secondary battery 102 in the energy-saving mode, the charge completion time required to complete charging, and the number of times the voltage drops.

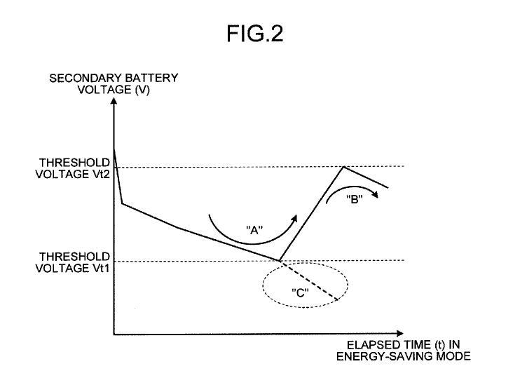

FIG. 2 is a graph depicting detection and control of the threshold voltage of the secondary battery 102 performed by the power supply threshold detection circuit 104 in FIG. 1. The graph indicates the relationship between threshold voltages Vt1 and Vt2 of the secondary battery 102 at elapsed time (t) in the energy-saving mode. In the part denoted by “A” in FIG. 2, the power supply threshold detection circuit 104 detects a voltage equal to or less than a threshold voltage Vt1. When the power supply threshold detection circuit 104 detects a voltage equal to or less than the threshold voltage Vt1, the energy-saving mode controller 11 starts causing the auxiliary charging circuit 103 to forcibly charge the secondary battery 102. In the part denoted by “B”, the power supply threshold detection circuit 104 detects a voltage equal to or more than a threshold voltage Vt2. The energy-saving mode controller 11 then switches the power source from the commercial power supply 110 to the secondary battery 102 in response to that detection result. In the part denoted by “C”, if the power supply threshold detection circuit 104 does not exist, the voltage of the secondary battery 102 continues dropping.

When the power supply threshold detection circuit 104 detects that the voltage of the secondary battery 102 is equal to or less than the threshold voltage Vt1, as shown in FIG. 2, the control circuit 105 blocks the route via which power is fed to the respective components of the image forming apparatus and the auxiliary charging circuit 103 starts forcibly charging the secondary battery 102. In order to continue in the energy-saving mode, the energy-saving mode controller 11 starts causing the auxiliary charging circuit 103 to perform forced charging and switches the feeding operation (the power source) from the secondary battery 102 to the main power supply 101. Because the voltage increases and exceeds a threshold voltage Vt2 when the auxiliary charging circuit 103 completes forced charging, the energy-saving mode controller 11 switches the power source to the secondary battery 102 again.

The power for the auxiliary charging circuit 103 to forcibly charge the secondary battery 102 is fed from the commercial power supply 110 and, when in operation, the secondary battery 102 is charged by the solar battery 111. The forced charging is performed in the energy-saving mode to avoid the secondary battery 102 not being able to be used when the charge level of the secondary battery 102 is equal to or less than the threshold voltage. In other words, charge from the commercial power supply 110 capable of emergency charging under any situation is performed taking into account the fact that the solar battery 111 depends on the weather and lighting.

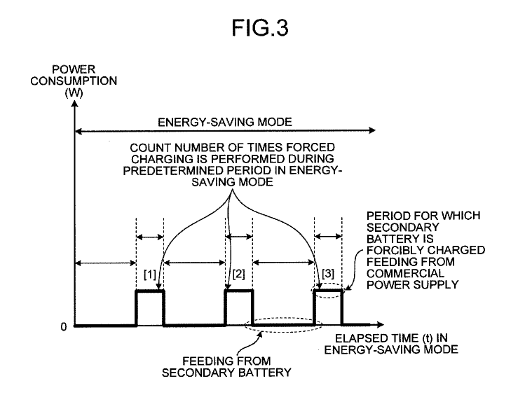

FIG. 3 is a graph depicting determination of the deterioration of the secondary battery 102 by monitoring the number of times the secondary battery 102 is forcibly charged. The graph depicts the count of the number of times the auxiliary charging circuit 103 forcibly charges the secondary battery 102 in a predetermined time in the energy-saving mode. In FIG. 3, [1], [2], and [3] indicate the period in which the secondary battery 102 is forcibly charged and indicate power consumption (W) during feeding from the commercial power supply 110. In addition, the power consumption (W) during feeding from the secondary battery 102 is shown below [1], [2], and [3]. As shown in FIG. 3, the secondary battery deterioration detector 10 counts the number of times the secondary battery 102 is forcibly charged during the predetermined period in the energy-saving mode (three times of [1], [2], and [3] in the example of FIG. 3). The counted number of times is compared to the number of times a normal battery would be forcibly charged during the predetermined period, which is the number of times previously stored in the storage unit 122. As a result of the comparison of data regarding the number of times of forced charging, if the number of times the secondary battery 102 is forcibly charged is larger, it is determined that there is a possibility of deterioration of the secondary battery 102.

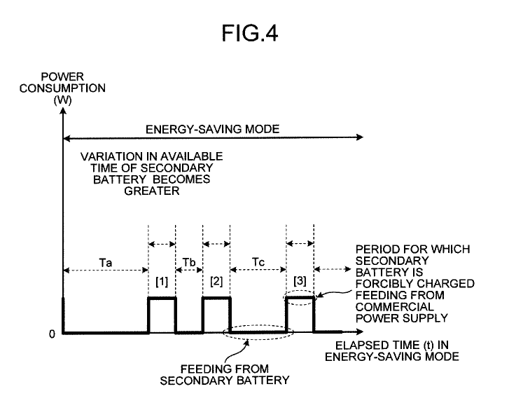

FIG. 4 is a graph depicting variation in the available time for the secondary battery 102. FIG. 4 depicts and contrasts feeding in the forced feeding period [1], [2], and [3] in which feeding from the commercial power supply is performed with variation in time Ta, Tb, and Tc in which feeding from the secondary battery 102 is performed in the energy-saving mode. A value predetermined taking into account variation in the available time for the secondary battery 102 and in the charge completion time is saved as the battery information 12 in the storage unit 122 of the controller unit 120. As shown in FIG. 4, during the predetermined period in the energy-saving mode, the energy-saving mode controller 11 saves the available time (Ta, Tb, and Tc) for the secondary battery 102 in the storage unit 122. When variation in the data is equal to or more than the predetermined value saved in the storage unit 122, the secondary battery deterioration detector 10 determines that there is a possibility of deterioration of the secondary battery 102.

In other words, when the discharge time of the secondary battery 102 changes each time as the time for which the secondary battery is used elapses and the available time greatly differs each time, the secondary battery deterioration detector 10 determines, according to the variation in data, that the secondary battery 102 deteriorates. Regarding FIG. 4, by storing, in the storage unit 122, time Ta for which feeding from the secondary battery 102 is performed in the energy-saving mode and by setting errors of Tb and Tc with respect to Ta as percentages, the energy-saving mode controller 11 determines that there is a possibility of deterioration of the secondary battery 102 according to the level of error.

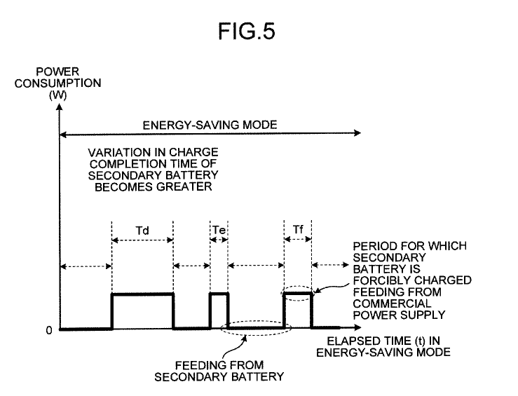

FIG. 5 is a graph depicting variation in the charge completion time of the secondary battery 102. FIG. 5 depicts variation in the charge completion time [Td], [Te], and [Tf] and in which feeding from the commercial power supply 110 is performed. As shown in FIG. 5, the energy-saving mode controller 11 saves the charge completion time of the secondary battery 102 (Td, Te, and Tf) in the storage unit 122 during the predetermined period in the energy-saving mode. When the variation in data is equal to or more than a predetermined value, the secondary battery deterioration detector 10 determines that there is a possibility of deterioration of the secondary battery 102.

In this example, when the charge completion time (Td, Te, Tf) changes each time as the time for which the secondary battery 102 is used elapses as described above and the time required to complete charging of the secondary battery 102 exceeds the predetermined error, the secondary battery deterioration detector 10 determines that there is a possibility of deterioration of the secondary battery 102.

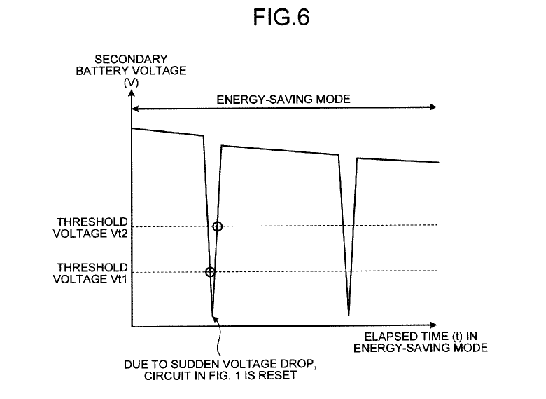

FIG. 6 is a graph depicting a sudden voltage drop of the secondary battery 102 in the energy-saving mode. The graph indicates the relationship between threshold voltages Vt1 and Vt2 of the secondary battery 102 at elapsed time (t) in the energy-saving mode and particularly indicates that a sudden voltage drop of the secondary battery 102 occurs at elapsed time (t) in the energy-saving mode. As shown in FIG. 6, the secondary battery deterioration detector 10 detects, by using the power supply threshold detection circuit 104, that the voltage is equal to or less than the threshold voltage Vt1 during a predetermined period in the energy-saving mode. After the detection, when the power supply threshold detection circuit 104 detects an increase equal to or more than the threshold voltage Vt2 within a predetermined time, the secondary battery deterioration detector 10 determines that a sudden voltage drop has occurred in the secondary battery 102. In other words, when a sudden voltage drop occurs, the secondary battery deterioration detector 10 determines that the secondary battery 102 is unstable.

In the example, when a sudden voltage drop of the secondary battery 102 occurs as shown in FIG. 6, the secondary battery deterioration detector 10 counts the number of times a sudden voltage drop occurs and saves the number of times. For example, when such a voltage reduction occurs three times or more during a single energy-saving mode, the secondary battery deterioration detector 10 determines that there is a possibility of deterioration of the secondary battery 102. When such a sudden voltage drop occurs, the power supply circuit unit 100 in FIG. 1 is reset.

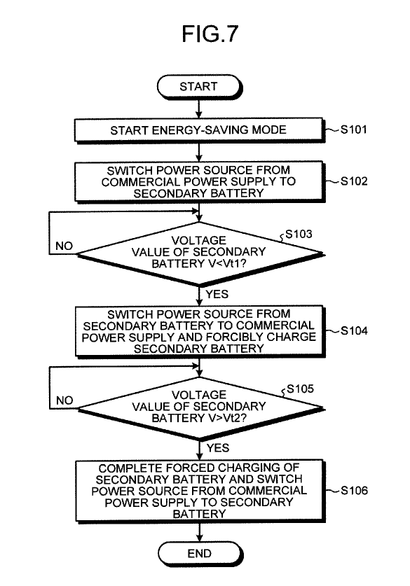

FIG. 7 is a flowchart of operations of the control of the secondary battery 102 in the energy-saving mode according to the embodiment. The control operations are overall performed by the controller unit 120 (CPU 121) on the power supply circuit unit 100 shown in FIG. 1. First, the energy-saving mode is started (step S101) and the operation is switched from the commercial power supply 110 to the secondary battery 102 (step S102). The secondary battery deterioration detector 10 then detects a voltage value V of the secondary battery 102 and determines whether the voltage value V and a threshold value Vt1 satisfy V<Vt1 (step S103). When the power supply threshold detection circuit 104 detects that the voltage value V is less than the threshold voltage Vt1 shown in FIG. 2 (YES), the energy-saving mode controller 11 switches the power source from the secondary battery 102 to the commercial power supply 110 to continue in the energy-saving mode. The CPU 121 also issues a command for forcibly charging the secondary battery 102 to the auxiliary charging circuit 103 (step S104). In contrast, when the power supply threshold detection circuit 104 detects that the voltage value V is more than the threshold voltage Vt1 at step S103 (NO), the energy-saving mode controller 11 performs the determination process at step S103 until the voltage becomes equal to or less than the threshold voltage Vt1.

The energy-saving mode controller 11 then detects a voltage value V of the secondary battery 102 and determines whether the voltage V and a threshold voltage Vt2 satisfy V>Vt2 (step S105). When it is determined that the forced charging of the secondary battery 102 is more than the threshold voltage Vt2 shown in FIG. 2 (YES), the energy-saving mode controller 11 switches the power source from the commercial power supply 110 to the secondary battery 102 (step S106). In contrast, when the power supply threshold detection circuit 104 detects that the voltage value V is less than the threshold voltage Vt2 at step S105 (NO), the energy-saving mode controller 11 performs the determination process at step S105 until the voltage value V becomes equal to or more than the threshold voltage Vt2.

As described above, by forcibly charging the secondary battery 102, use of the commercial power supply 110 can be reduced in the energy-saving mode and power consumption can be thus reduced.

The program executed in the embodiment is provided by previously installing the program in the storage unit 122. However, the provision of the program is not limited to this. The program executed in the embodiment may be provided as a computer program product by recording the program as a file in an installable format or an executable format in a computer-readable medium, such as a CD-ROM, a flexible disk (FD), a CD-R, or a digital versatile disk (DVD).

The program executed in the embodiment may be stored in a computer that is connected to a network, such as the Internet, and may be provided by downloading the program via the network. Alternatively, the program executed in the embodiment may be provided or distributed via a network, such as the Internet.

The program executed in the embodiment may be configured as a module configured by the CPU 121 including the secondary battery deterioration detector 10 and the energy-saving mode controller 11. The actual hardware that makes up the CPU 121 (processor) reads the program from the recoding medium and executes the program so that the program is loaded on a main storage device, such as the storage unit 122, and accordingly the secondary battery deterioration detector 10 is generated on the main storage device.

According to the embodiment, because deterioration of a secondary battery is detected and control is performed in consideration of deterioration of the secondary battery, it is possible to maintain the effects of reducing power consumption.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising:
a main power supply configured to feed power to components of the image forming apparatus;
a secondary battery configured to be charged with power from the main power supply or a solar battery;
a secondary battery deterioration detector configured to monitor a charging voltage drop of the secondary battery and to detect deterioration of the secondary battery;
a secondary battery charge unit configured to charge the secondary battery when the secondary battery deterioration detector detects deterioration of the secondary battery in an energy-saving mode; and
an energy-saving mode control unit configured to switch a power source for the image forming apparatus from the secondary battery to the main power supply to continue in the energy-saving mode when the secondary battery deterioration detector detects deterioration of the secondary battery in the energy-saving mode.

2. The image forming apparatus according to claim 1, further comprising a storage unit configured to store therein the number of times the secondary battery is charged by the secondary battery charge unit during a predetermined period in the energy-saving mode and a reference number of times a normal battery would be forcibly charged during the predetermined period,
wherein the secondary battery deterioration detector compares the number of times the secondary battery is charged during the predetermined period in the energy-saving mode with the reference number of times, to detect deterioration of the secondary battery.

3. The image forming apparatus according to claim 1, further comprising a storage unit configured to store therein an available time for the secondary battery from completion of charging to the start of next charging during a predetermined period in the energy-saving mode,
wherein when the available time exceeds a predetermined allowable range, the secondary battery deterioration detector determines that the secondary battery deteriorates.

4. The image forming apparatus according to claim 1, further comprising a storage unit that stores therein a charge completion time of the secondary battery from the start of charging to completion of charging during a predetermined period in the energy-saving mode,
wherein when the charge completion time exceeds a predetermined allowable range, the secondary battery deterioration detector detects that the secondary battery deteriorates.

5. The image forming apparatus according to claim 1, further comprising a storage unit configured to store therein the number of times a sudden voltage reduction occurs in the secondary battery during a predetermined period in the energy-saving mode,
wherein when the number of times a sudden voltage reduction occurs is equal to or more than a predetermined number of times, the secondary battery deterioration detector detects that the secondary battery deteriorates.

6. The image forming apparatus according to claim 1, further comprising a notification unit configured to notify a user of an appropriate period of replacement of the secondary battery when the secondary battery deterioration detector detects that the secondary battery deteriorates.

7. A feeding control method performed by an image forming apparatus that includes a main power supply configured to feed power to components of the image forming apparatus and a secondary battery configured to be charged with power from the main power supply or a solar battery, the feeding control method comprising:
detecting deterioration of the secondary battery by monitoring a charging voltage drop of the secondary battery;
charging the secondary battery when deterioration of the secondary battery is detected in an energy-saving mode; and
switching a power source for the image forming apparatus from the secondary battery to the main power supply to continue in the energy-saving mode when deterioration of the secondary battery is detected in the energy-saving mode.

8. A computer program product comprising a non-transitory computer readable medium including programmed instructions, wherein the instructions, when executed by a processor of an image forming apparatus that includes a main power supply configured to feed power to components of the image forming apparatus and a secondary battery configured to be charged with power from the main power supply or a solar battery, cause the processor to execute:
detecting deterioration of the secondary battery by monitoring a charging voltage drop of the secondary battery;
charging the secondary battery when deterioration of the secondary battery is detected in an energy-saving mode; and
switching a power source for the image forming apparatus from the secondary battery to the main power supply to continue in the energy-saving mode when deterioration of the secondary battery is detected in the energy-saving mode.
